(19) United States
(12) Patent Application Publication
(10) Pub. No.: US 2008/0158877 A1
(43) Pub. Date: Jul. 3, 2008

(54) BACKLIGHT MODULES AND DISPLAYS USING THE SAME

(75) Inventors: Pao-Ju Hsieh, Hsinchu City (TW); Hui-Lung Kuo, Taipei City (TW); Mei-Chih Peng, Taoyuan County (TW); Chun-Hsiang Wen, Hsinchu City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/775,137

(22) Filed: Jul. 9, 2007

(30) Foreign Application Priority Data
Dec. 28, 2006 (TW) TW95149474

(51) Int. Cl. F21V 9/14; F21V 5/02

(52) U.S. Cl. 362/235

(57) ABSTRACT

A backlight module and a display using the same are disclosed. The backlight module includes an emitting device having a plurality of light emitting elements controlled by a color sequential method and a polarizing module on the emitting device. The display further has a display panel and a polarizer plate. The display panel is disposed between the polarizer plate and the backlight module.

### BACKGROUND OF THE INVENTION

1. Field of the Invention

The invention relates to backlight modules for displays, and more particularly to backlight modules producing polarized light.

2. Description of the Related Art

Liquid crystal displays (LCD) are employed in a wide variety of mobile electric devices due to their scalability, low weight, power efficiency and high brightness. An LCD typically comprises liquid crystal and array electrodes interposed between two polarizer plates. Because liquid crystals do not emit light, LCDs employ a backlight module as a light source. Light emitted by the backlight module enters the polarizer plate, the light is then polarized in conjunction with the twisted liquid crystal molecules, causing a variation in brightness for image display.

FIG. 1 is a schematic view showing a conventional liquid crystal display 10. A liquid crystal display panel 14 is sandwiched between an upper polarizer plate 15 and a lower polarizer plate 13. The lower polarizer plate 13 is disposed between the liquid crystal display panel 14 and a backlight module 11. Typically, the lower polarizer plate 13 is an absorbent polarizer plate. The backlight module 11 may comprise incandescent lamps. The backlight module 11 may alternatively comprise red, green and blue light emitting diodes (LEDs) controlled by a color sequential method as shown in FIG. 1. A light collector and light guiding module 12 is disposed between the backlight module 11 and the lower polarizer plate 13. Light produced from the backlight module 11 enters the light collector and light guiding module 12 for concentrating and emitting uniform light. An image quality of the LCD 10 may be improved by employing the light collector and light guiding module 12.

In a conventional LCD, the lower polarizer plate may be a dichoroic polarizer, which may absorb half the available incident light, thus, largely blocks the source luminescence. The final perceptively brightness of the conventional LCD is about 4˜6% of the brightness of the light source. Thus, the absorbent polarizer plate significantly reduces luminescent efficiency.

Additionally, high performance, high resolution and simplified LCDs are desirable.

### BRIEF SUMMARY OF THE INVENTION

The invention provides backlight modules and displays using the same. In one embodiment of the invention, a backlight module comprises an emitting device comprising a plurality of light emitting elements controlled by a color sequential method and a polarizing module disposed on the emitting device.

In another embodiment of the invention, a display comprises a backlight module, an upper polarizer plate and a display panel between the polarizer plate and the backlight module. Wherein the backlight module comprises an emitting device comprising a plurality of light emitting elements controlled by a color sequential method and a polarizing module disposed on the emitting device.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view showing a conventional liquid crystal display;

FIG. 2 is a schematic view showing a display according to an embodiment of the invention;

FIG. 3 is a schematic view showing the polarizing module according to an embodiment of the invention;

FIG. 4a to 4c are schematic views showing the polarizer film according to various embodiments of the invention;

FIGS. 5 to 8 are schematic view showing polarizing modules according to various embodiments of the invention;

FIG. 9 is a diagram showing polarizing efficiency with varied wavelengths of a polarizing module according to an embodiment of the invention; and

FIG. 10 is a diagram showing brightness enhancement efficiency of a polarizing module compared to a conventional absorbent polarizer plate according to an embodiment of the invention.

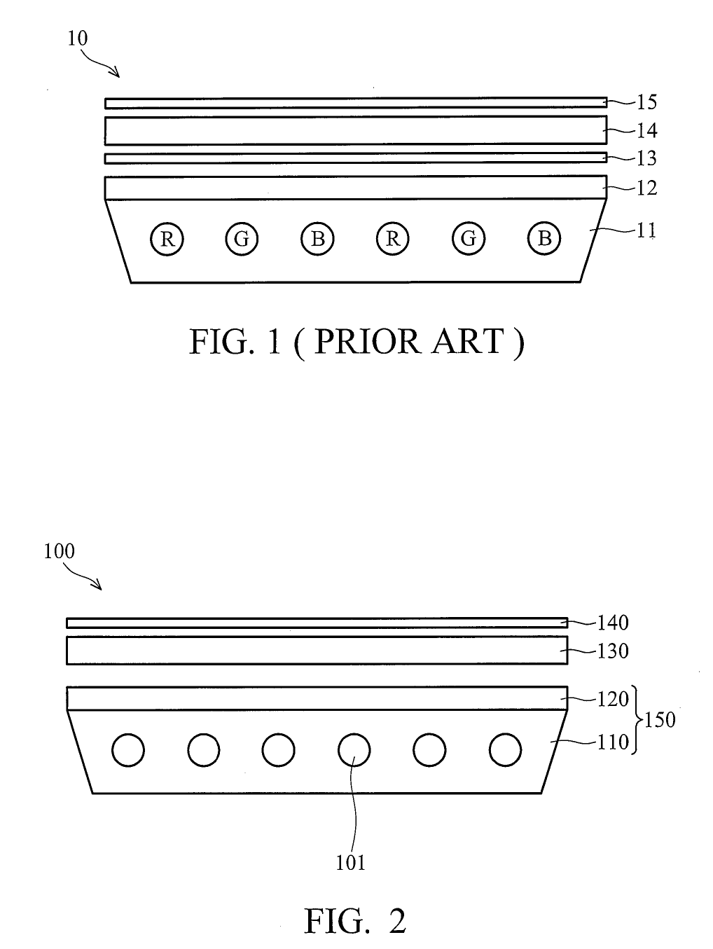

### DETAILED DESCRIPTION OF THE INVENTION

The following description is the best-contemplated mode of carrying out the invention. This description is made for the purpose of illustrating the general principles of the invention and should not be taken in a limiting sense. The scope of the invention is best determined by reference to the appended claims.

FIG. 2 is a schematic view showing a display according to an embodiment of the invention. Referring to FIG. 2, a display 100 may comprise a display panel 130, a backlight module 150 and an upper polarizer plate 140. The display panel 130 may be disposed between the upper polarizer plate 140 and the backlight module 150. The backlight module 150 may comprise an emitting device 110 and a polarizing module 120 disposed on the emitting device 110. The emitting device 110 may comprise a plurality of light emitting elements 101 controlled by a color sequential method. Each light emitting element 101 may be driven by an independent integrated circuit (IC). For example, the display 100 may be a thin film transistor liquid crystal display (TFT-LCD). The display panel 130 may be a liquid display panel comprising an upper glass substrate, a lower glass substrate and a liquid crystal layer sandwiched between the upper and lower glass substrates (not shown). The emitting device 110 may comprise the light emitting elements 101 such as a plurality of light emitting diodes (LEDs). The light emitting elements 101 preferably comprise red, blue and green (RGB) light sources.

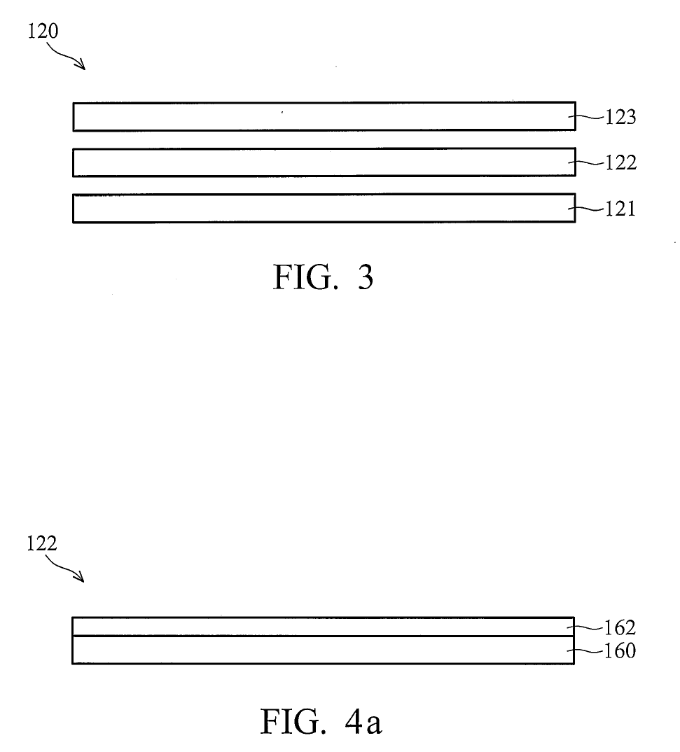

In this embodiment of the invention, because the backlight module 150 comprises the polarizing module 120 on the emitting device 110, the backlight module 150 can produce polarized light sources. Compared to a conventional LCD, a polarizer plate, such as a lower polarizer plate, can be eliminated from the display structure 100. FIG. 3 is a schematic view showing the polarizing module 120 according to an embodiment of the invention. The polarizing module 120 may comprise a reflective polarizer film 122. The polarizing module 120 preferably comprises a diffuser plate 121 and a prism sheet 123 disposed below and on the reflective polarizer film 122 respectively. Light from a light source may be made uniform by the diffuser plate 121. The prism sheet 123 may comprise a prism plate for concentrating light. In this embodiment, the reflective polarizer film 122 is disposed between the diffuser plate 121 and the prism sheet 123 and is not adhered to the diffuser plate 121 and the prism sheet 123.

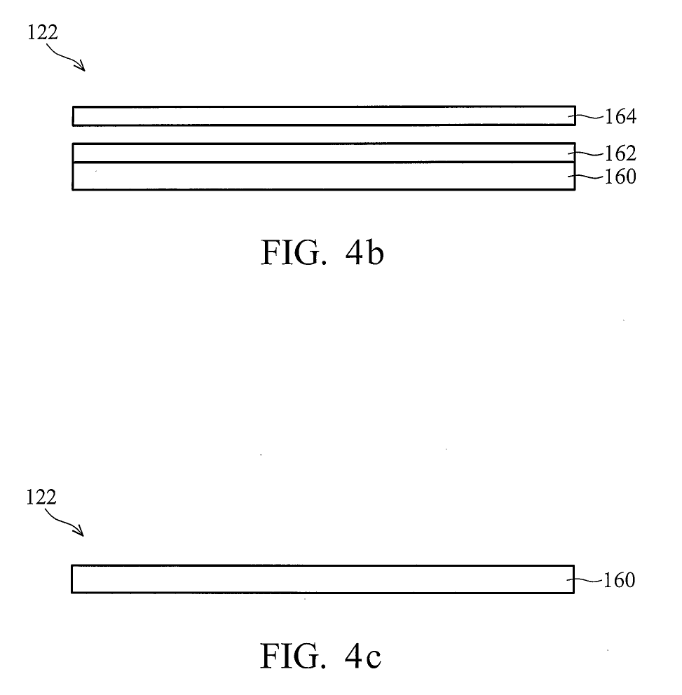

FIG. 4a to 4c are schematic views showing the reflective polarizer film 122 of various embodiments of the invention. Referring to FIG. 4a, the reflective polarizer film 122 may comprise a cholesteric liquid crystal reflective polarizer film 160 and a quarter wavelength retardation film 162. The cholesteric liquid crystal reflective polarizer film 160 may be adhered to the quarter wavelength retardation film. The cholesteric liquid crystal reflective polarizer film 160 characteristically converts unpolarized light into circularly polarized light as arranged in planar orientation. In order to cover fully visible range, the cholesteric liquid crystal layer has several different pitches in thickness direction. Additionally, the cholesteric liquid crystal layer may a single-layered or multi-layered structure. Moreover, the dimensional variation of the pitches may successively increase, successively decrease, non-continuously increase or non-continuously decrease. Furthermore, the spectra of the cholesteric liquid crystal reflective polarizer film 160 may be designed according to emitted spectra of the emitting device 110. That is, the cholesteric liquid crystal layer may be designed according to red, green and blue LED light spectra. Since the light separating mechanism of cholesteric liquid crystal reflective polarizer film 160 is similar to Bragg reflection, it can perform higher luminescent efficiency than a conventional absorbent polarizer plate.

The quarter wavelength retardation film 162 transforms the circularly polarized light into linearly polarized light. The quarter wavelength retardation film 162 may be a single-layered or multi-layered structure.

In another embodiment of the invention, the reflective polarizer film 122 may comprise the cholesteric liquid crystal reflective polarizer film 160, the quarter wavelength retardation film 162 and a contrast enhancement film 164 as shown in FIG. 4b. The quarter wavelength retardation film 162 is disposed between the cholesteric liquid crystal reflective polarizer film 160 and the contrast enhancement film 164. The cholesteric liquid crystal reflective polarizer film 160 may be adhered to the quarter wavelength retardation film 162. The quarter wavelength retardation film 162 may not be adhered to the contrast enhancement film 164. The function of the contrast enhancement film 164 may be similar to polarizing film for better image quality enhancement.

In another embodiment of the invention, the reflective polarizer film 122 transforms un-polarized light into circularly polarized light. Referring to FIG. 4c, the reflective polarizer film 122 may comprise cholesteric liquid crystal reflective polarizer film 160 but not a quarter wavelength retardation film.

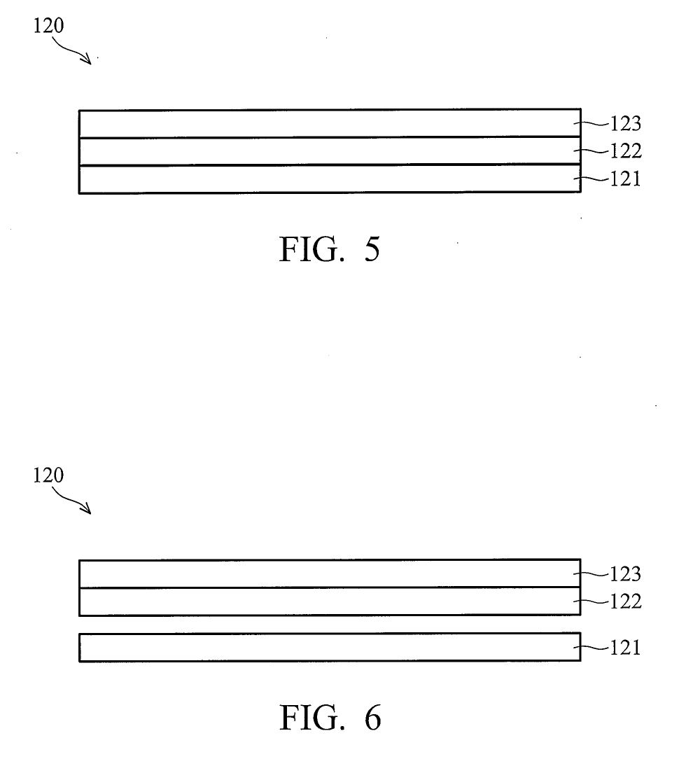

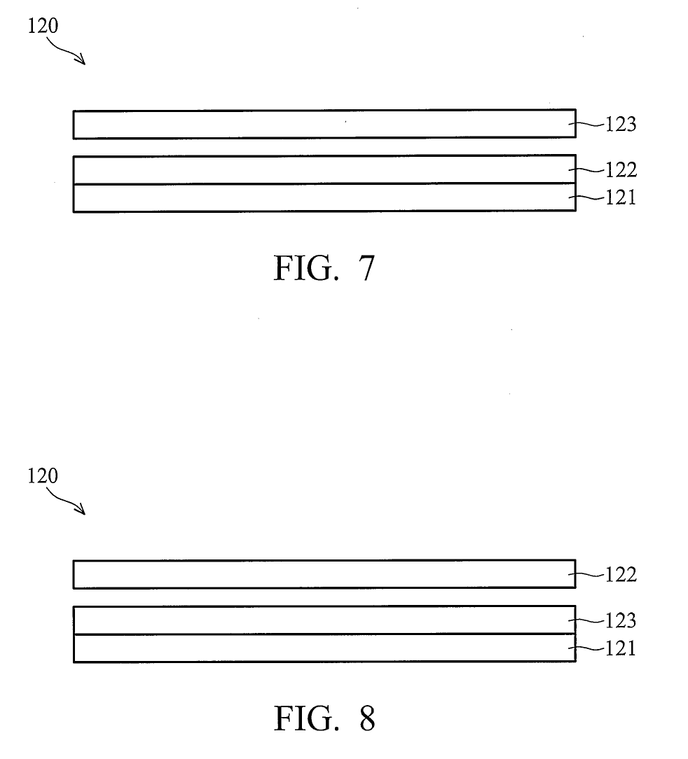

FIG. 5 to FIG. 8 are schematic views showing polarizing modules 120 of various embodiments of the invention. Polarizing module 120 may comprise reflective polarizer film 122 disposed between and adhered to diffuser plate 121 and prism sheet 123 as shown in FIG. 5. Referring, FIG. 6, the polarizing module 120 may comprise the reflective polarizer film 122 disposed between the diffuser plate 121 and the prism sheet 123. The reflective polarizer film 122 may be adhered to the prism sheet 123 but not the diffuser plate 121. Referring to FIG. 7, the polarizing module 120 may comprise the reflective polarizer film 122 between the diffuser plate 121 and the prism sheet 123. The reflective polarizer film 122 may be adhered to the diffuser plate 121 but not the prism sheet 123. Referring to FIG. 8, polarizing module 120 may comprise prism sheet 123 disposed between the reflective polarizer film 122 and the diffuser plate 121. The prism sheet 123 may be adhered to diffuser plate 121 but not reflective polarizer film 122.

### EXAMPLES

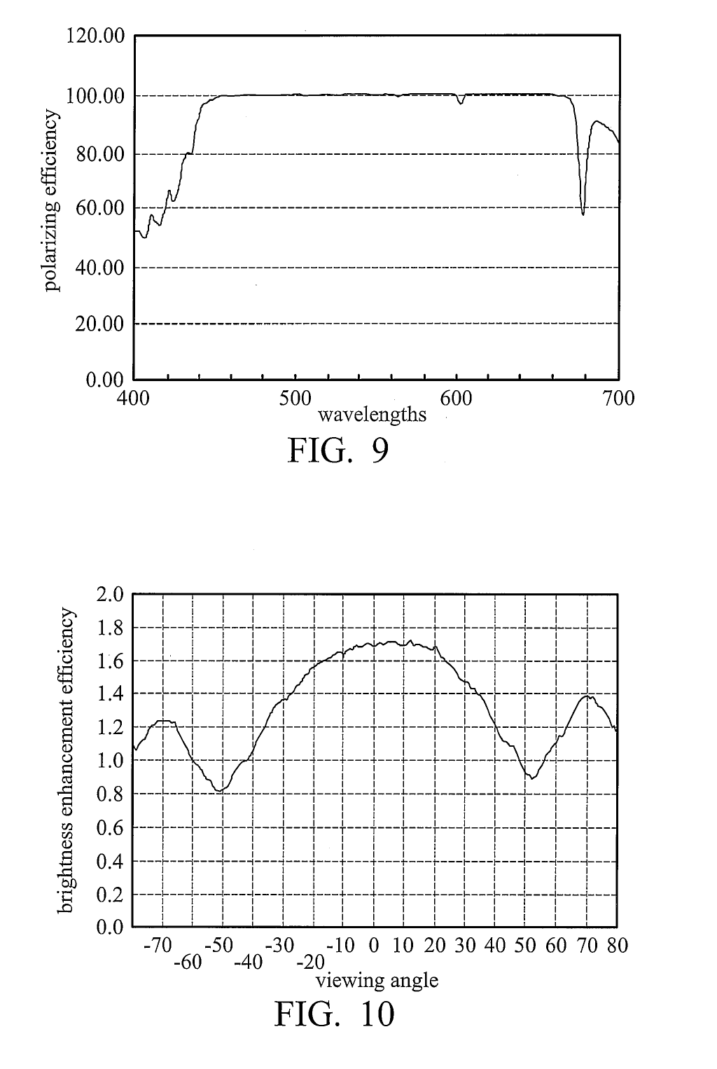

FIG. 9 is a diagram showing polarizing efficiency with different wavelengths of a polarizing module according to an embodiment of the invention. The polarizing efficiency in the diagram is based on measuring a polarizing module including a cholesteric liquid crystal reflective polarizer film and a quarter wavelength retardation film. The result shows that the polarizing efficiency of the polarizing module of the invention reaches above about 99.5%.

FIG. 10 is a diagram showing brightness enhancement efficiency of a polarizing module compared to a conventional absorbent polarizer plate according to an embodiment of the invention. The diagram shows that the brightness enhancement efficiency of the polarizing module is about 1.7 times greater than the conventional absorbent polarizer plate at the normal viewing angle. The average brightness enhancement efficiency of the polarizing module is about 1.6 times greater than the conventional absorbent polarizer plate at the viewing angle around 30 degrees.

According to the described embodiments, the inventive display comprises a backlight module producing polarized colored light source. Because an emitting device in the backlight module may comprise light emitting elements controlled by a color sequential method, a color filter can be eliminated from the display and because the backlight module may comprise a polarizing module, a lower polarizer plate can be eliminated from the display. Compared to a conventional display, the display according to an embodiment of the invention has relatively higher brightness efficiency, a simplified structure, thus, manufacturing cost and weight are reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module for a display, comprising
an emitting device comprising a plurality of light emitting elements controlled by a color sequential method; and
a polarizing module disposed on the emitting device.

2. The backlight module for a display as claimed in claim 1, wherein the polarizing module comprises a polarizer film.

3. The backlight module for a display as claimed in claim 2, wherein the polarizing module comprises a diffuser plate.

4. The backlight module for a display as claimed in claim 2, wherein the polarizing module comprises a prism sheet.

5. The backlight module for a display as claimed in claim 2, wherein the polarizer film comprises a cholesteric liquid crystal reflective polarizer film.

6. The backlight module for a display as claimed in claim 5, the polarizer film comprises a quarter wavelength retardation film.

7. The backlight module for a display as claimed in claim 6, wherein the polarizer film comprises a contrast enhancement film.

8. The backlight module for a display as claimed in claim 1, wherein the light emitting elements comprise red, green and blue light source.

9. The backlight module for a display as claimed in claim 4, wherein the light collector film comprises a prism plate.

10. A display, comprising:
a backlight module comprising:
an emitting device comprising a plurality of light emitting elements controlled by a color sequential method; and
a polarizing module disposed on the emitting device;
an upper polarizer plate; and
a display panel disposed between the polarizer plate and the backlight module.

11. The display as claimed in claim 10, wherein the polarizing module comprises a polarizer film.

12. The display as claimed in claim 11, wherein the polarizing module comprises a diffuser plate.

13. The display as claimed in claim 11, wherein the polarizing module comprises a light collector plate.

14. The display as claimed in claim 11, wherein the polarizer film comprises a cholesteric liquid crystal reflective polarizer film.

15. The display as claimed in claim 14, wherein the polarizer film comprises a quarter wavelength retardation film.

16. The display as claimed in claim 15, wherein the polarizer film comprises a contrast enhancement film.

17. The display as claimed in claim 10, wherein the light emitting elements comprise red, green and blue light sources.

18. The display as claimed in claim 13, wherein the light collector film comprises a prism plate.

19. The display as claimed in claim 10, wherein the display panel comprises a liquid crystal display.

20. The display as claimed in claim 10, wherein the light emitting elements comprise light emitting diodes.
